(19) United States
(12) Patent Application Publication
(10) Pub. No.: US 2025/0369911 A1
(43) Pub. Date: Dec. 4, 2025

(54) Devices, Systems, and Methods for Fluidic Testing Cartridges

(71) Applicant: IDEXX Laboratories, Inc., Westbrook, ME (US)

(72) Inventor: Michael Schrameyer, Portland, ME (US)

(21) Appl. No.: 19/219,235

(22) Filed: May 27, 2025

Related U.S. Application Data
(60) Provisional application No. 63/653,651, filed on May 30, 2024.

(51) Int. Cl. G01N 27/30; B01L 3/00

(52) U.S. Cl. CPC G01N 27/30; B01L 3/502; B01L 2300/047; B01L 2300/0645; B01L 2300/0816; B01L 2300/0861

(57) ABSTRACT

A cartridge for testing a sample is disclosed. In some examples, the cartridge includes a plurality of electrodes, a sample reservoir comprising an inlet and a sample gate, and at least one channel, wherein each channel of the at least one channel is in selective fluidic communication with the sample reservoir. In some examples, each channel of the at least one channel includes a channel gate, reagent reservoir, a reagent gate, a detection reservoir, and an analysis location. In some examples, the cartridge also includes a tip axis, and the tip axis is transverse to the at least one channel and a tilt axis of the cartridge.

### RELATED APPLICATION

This application claims priority to U.S. Provisional Application No. 63/653,651 Filed on May 30, 2024, which is incorporated herein by reference in its entirety.

### FIELD OF THE DISCLOSURE

The present disclosure involves preparing and testing a sample (e.g., a biological sample) utilizing a cartridge that employs surface treatments with specific liquid contact angles (capillary forces), electrowetting on dielectric (EWOD) technologies, gravitational forces, and tip and tilt axes, among other technologies, to perform analysis on the sample.

### BACKGROUND

Assays (including immunoassays) and other analytical evaluations (e.g., polymerase chain reaction (PCR) tests) can be conducted on one or more portions of a sample utilizing a variety of different methods, including by utilizing a plurality of particles and other components of a droplet of the solution containing the sample to assist in performing the assays and other analytical evaluations.

### SUMMARY

In an example, a cartridge for testing a sample is disclosed. In an example, the cartridge includes a plurality of electrodes, a sample reservoir comprising an inlet and a sample gate, wherein the sample gate manipulates the sample on a surface of the cartridge via the plurality of electrodes, and wherein the sample reservoir is located at a first end of the cartridge, and at least one channel, wherein each channel of the at least one channel is in selective fluidic communication with the sample reservoir. In examples, each channel of the at least one channel includes: (i) a channel gate, wherein the channel gate manipulates the sample at a first location of the at least one channel on the surface of the cartridge via the plurality of electrodes; (ii) a reagent reservoir; (iii) a reagent gate, wherein the reagent gate manipulates a reagent at a second location of the at least one channel on the surface of the cartridge via the plurality of electrodes; (iv) a detection reservoir, wherein the detection reservoir includes a barrier configured to separate the detection reservoir from the reagent reservoir, and wherein the wherein the detection reservoir is located at a second end of the cartridge distal from the first end; and (v) an analysis location, wherein the analysis location is positioned proximate to a tip axis of the cartridge, and wherein the tip axis is transverse to the at least one channel and a tilt axis of the cartridge.

In another example, a method for testing a sample is disclosed. The method includes withdrawing a volume of the sample from a sample reservoir of a cartridge via a sample gate. The method further includes rotating the cartridge in a first direction around an axis of the cartridge, wherein rotating the cartridge allows communication of the sample into a first portion of at least one channel of the cartridge in fluid communication with the sample reservoir. The method also includes opening a channel gate between the first portion of the at least one channel and a second portion of the at least one channel, wherein opening the channel gate allows communication of the sample into the second portion of the at least one channel, and wherein the second portion of the at least one channel comprises an analysis location. The method further includes rotating the cartridge in a second direction around the axis of the cartridge, wherein the second direction is opposite the first direction, and wherein rotating the cartridge in the second directions promotes communication of the sample into the first portion of the at least one channel. The method also includes closing the channel gate to inhibit communication of the sample into the second portion of the at least one channel. The method further includes opening a reagent gate between the second portion of the at least one channel and a reagent reservoir, wherein opening the reagent gate allows fluidic communication between the second portion of the at least one channel and the reagent reservoir, and wherein the reagent reservoir comprises a reagent. The method also includes displacing a detection reservoir barrier between the reagent reservoir and a detection reservoir, wherein displacing the detection reservoir barrier allows fluidic communication between the second portion of the at least one channel, the reagent reservoir, and the detection reservoir.

In another example, a system for testing a sample is disclosed. In an example, the system includes a cartridge. In an example, the cartridge includes a plurality of electrodes, a sample reservoir comprising an inlet and a sample gate, wherein the sample gate manipulates the sample on a surface of the cartridge via the plurality of electrodes, and wherein the sample reservoir is located at a first end of the cartridge, and at least one channel, wherein each channel of the at least one channel is in selective fluidic communication with the sample reservoir. In examples, each channel of the at least one channel includes: (i) a channel gate, wherein the channel gate manipulates the sample at a first location of the at least one channel on the surface of the cartridge via the plurality of electrodes; (ii) a reagent reservoir; (iii) a reagent gate, wherein the reagent gate manipulates a reagent at a second location of the at least one channel on the surface of the cartridge via the plurality of electrodes; (iv) a detection reservoir, wherein the detection reservoir comprises a barrier configured to separate the detection reservoir from the reagent reservoir, and wherein the detection reservoir is located at a second end of the cartridge distal from the first end; and (v) an analysis location, wherein the analysis location is positioned proximate to a tip axis of the cartridge, and wherein the tip axis is transverse to the at least one channel and a tilt axis of the cartridge. In examples, the system also includes an imaging device. In examples, the imaging device includes an imaging sensor configured to capture one or more images of the sample in the detection reservoir and a computing device configured to analyze the captured one or more images.

The features, functions, and advantages that have been discussed can be achieved independently in various examples or may be combined in yet other examples. Further details of the examples can be seen with reference to the following description and drawings.

### BRIEF DESCRIPTION OF THE FIGURES

The above, as well as additional features will be better understood through the following illustrative and non-limiting detailed description of example embodiments, with reference to the appended drawings.

FIG. 1 illustrates a simplified block diagram of an example computing device, according to an example embodiment.

FIG. 2A illustrates a cartridge for testing a sample, according to an example embodiment.

FIG. 2B illustrates a section view of the cartridge of FIG. 2A in a second position, according to an example embodiment.

FIG. 3 illustrates a computing system configured for use with an imaging device and a mobile computing device, according to an example embodiment.

FIG. 4 illustrates a method, according to an example embodiment.

All the figures are schematic, not necessarily to scale, and generally only show parts which are necessary to elucidate example embodiments, wherein other parts may be omitted or merely suggested.

### DETAILED DESCRIPTION

Example embodiments will now be described more fully hereinafter with reference to the accompanying drawings. That which is encompassed by the claims may, however, be embodied in many different forms and should not be construed as limited to the embodiments set forth herein; rather, these embodiments are provided by way of example. Furthermore, like numbers refer to the same or similar elements or components throughout.

Within examples, the present disclosure is directed to devices, systems, and methods for testing a sample (e.g., a biological sample) utilizing a cartridge that employs surface treatments with specific liquid contact angles (capillary forces), electrowetting on dielectric (EWOD) technologies, gravitational forces, and tip and tilt axes, among other technologies, to perform analysis on the sample.

Testing and/or analyzing, as referred to herein, may include, for example, capturing one or more images related to a sample. For example, testing can involve capturing images of a sample from an imaging sensor and determining a stain intensity. In examples, testing can further involve modifying an intensity of a light source, then capturing one or more additional images from the imaging sensor. One or more machine learning models can then be implemented to analyze the captured images and perform one or more computational actions, including identifying a characteristic of the sample.

In another example, these images may come from competitive immunoassays for detection of antibodies in the sample and a competitive immunoassay may be carried out in the following illustrative manner. A sample (e.g. from an animal's body fluid) potentially containing an antibody of interest that is specific for an antigen, is contacted with the antigen attached to the particle and with the anti-antigen antibody conjugated to a detectable label. The antibody of interest, present in the sample, competes with the antibody conjugated to a detectable label for binding with the antigen attached to the particles. The amount of the label associated with the particles can then be determined after separating unbound antibody and the label. The signal obtained is inversely related to the amount of antibody of interest present in the sample.

In an alternative example embodiment of a competitive immunoassay, a sample (e.g. from an animal's body fluid) potentially containing an analyte, is contacted with the analyte conjugated to a detectable label and with an anti-analyte antibody attached to the particle. The antigen in the sample competes with analyte conjugated to the label for binding to the antibody attached the particle. The amount of the label associated with the particles can then be determined after separating unbound antigen and label. The signal obtained is inversely related to the amount of analyte present in the sample. The term “analyte,” as used herein, generally refers to the substance, or set of substances in a sample that are detected and/or measured, either directly or indirectly. In various aspects the assays of the disclosure, examples include sandwich immunoassays that capture an analyte in a sample between a binding member (e.g., an antibody) attached to the particles and a second binding member for the analyte that is associated with a label.

Antibodies, antigens, and other binding members (e.g., aptamers) may be attached to the particle or to the label directly via covalent binding with or without a linker or may be attached through a separate pair of binding members as is well known (e.g., biotin:streptavidin, digoxigenin:anti-digoxiginen). In addition, while the examples herein reflect the use of immunoassays, the particles and methods of the disclosure may be used in other receptor binding assays (including nucleic acid hybridization assays) that rely on immobilization of one or more assay components to a solid phase. In other examples, one or more binding members may attach to the particle or particles (collectively referred to herein as “assembled particles”), which in turn may be washed in preparation for testing. In an example embodiment, during this washing portion, one or more components may be used to facilitate the assembly and/or washing of the assembled particles, including one or more components of a cartridge to secure the particles prior to assembly and/or after assembly in one or more portions of the cartridge.

In example embodiments, these characteristics may be referred to herein as a “unique identifying feature” and/or “parameter” of the particles, assembled particles, and/or of droplet in which these particles reside. Other examples are possible. For example, the particles may also bind to a fluorescent tag or label, which may present a “unique identifying feature” and/or “parameter” of particles to which the fluorescent tag or label might bind under a fluorescent and/or ultraviolet lighting. Other improvements may be realized.

In other examples, a sample may be extracted (e.g., from an animal's body fluid) and undergo PCR preparation and testing in order to image and/or otherwise analyze one or more characteristics of the sample. To do so, in example embodiments, the devices, systems, and methods described herein may be used to perform one or more portions of a PCR preparation and testing, including thermocycling to amplify and detect one or more specific target sequences within a sample. In example embodiments, PCR thermocycling may include preparing the extracted sample (e.g., a fecal prepared with clarified lysate) and then establishing multiple temperature zones within various portions of a cartridge to promote various one or more portions of the PCR preparation. In example embodiments, these multiple temperature zones including a first temperature zone to denature one or more specific target sequences within a sample (e.g., 95 degrees Celsius (° C.)), a second temperature zone to anneal the denatured one or more specific target sequences (e.g., 60° C.), and a third temperature zone to elongate the annealed one or more specific target sequences (e.g., 72° C.). By doing so, in example embodiments, during each temperature cycle of the PCR thermocycling (e.g., 95° C. denature, 60° C. anneal, 72° C. elongate) there can be a doubling of the one or more target sequences, which improves the detection of specific target sequences by improving detection of the one or more target sequences by improving, among other modalities, amplification of the one or more target sequences. In example embodiments, PCR detection may include detection of viruses and/or common infectious pathogens, including diarrhea pathogens.

Conventionally, these assays and analytical evaluations have been conducted on preconfigured and prefabricated testing platforms.

One such platform includes a single lane diagnostic tool that utilizes one or more wicking materials to mobilize a liquid droplet of sample (e.g., a urine sample) to test for a single assay and/or other analytical result based on a chemical reaction between one or more portions of the sample and one or more reagents in the materials of the diagnostic tool. However, these chemistry-based tests do not require capture, wash, and detection fluids used in more complex tests like immunoassays and PCR. Further, these platforms typically provide a single test and/or provides a single testing result.

Another such platform includes preconfigured cartridges that utilize one or more electrodes to manipulate and/or otherwise control individual droplets of a liquid on a surface of the cartridge along one or more paths defined by the plurality of electrodes on one or more surfaces of one or more materials, including a printed circuit board (PCB), semiconductor photolithography, conductive patterning on glass, conductive patterning on ceramic, and/or conductive patterning on plastic, among other possibilities. In examples, these cartridges may utilize a plurality of electrodes that facilitate transportation of individual droplets of a liquid on a surface of the cartridge. To do so, in one example embodiment, the cartridge surface may comprise a dielectric materials and transport the individual droplets along one or more paths defined by the plurality of electrodes on a PCB. In example embodiments, the dielectric materials may comprise a hydrophobic material, layer, and/or coating disposed on the surface of the PCB and/or plurality of electrodes, the combination of which is referred to herein as the “dielectric cartridge surface” and/or a “path” or “paths” along the dielectric cartridge surface. Such techniques are often referred to as EWOD.

To date, such cartridges have involved a complicated, interwoven series of paths along the dielectric cartridge surface that are controlled via a network of electrodes to define and facilitate transportation along these complicated paths. Due to a number of factors, including the manufacturing costs of such cartridges, there exists a need to optimize cartridges to be able to execute various steps of testing protocols, but not include components that are extraneous to the desired testing protocols. Further, the more complicated the configuration of the cartridge, the more distance and component interaction with the fluid that travels along these paths are required. This complication adds cost, time, and even potential error to one or more parts of the testing protocol and is often limited to performing a single analytical test and/or evaluation per sample and per cartridge. Thus, there exists a need for a cartridge that utilizes some, but not all of conventional EWOD technology to effectively manipulate and/or otherwise control transportation of a droplet on a surface of the cartridge and allow multiple tests on the same sample in a single cartridge, all with less expensive and/or complicated arrangement than current EWOD cartridges provide.

Embodiments of the present disclosure provide a cartridge that utilizes, among other technologies, EWOD and tip/tilt fluidic manipulation for testing a fluid sample. In the examples described herein, a cartridge is configured to perform complex tests, like immunoassays and PCR, by introducing one or more on-board reagents for multiple testing protocols (e.g., detecting the presence of one more analytes and also performing a PCR test) on a single sample in a single cartridge, simultaneously. To do so, the cartridge utilizes a plurality of channels with respective on-board reagents and detection reservoirs to prepare the sample for and perform multiple tests at once, all with minimal user interaction. Additionally, the cartridge and associated methods described herein allow for thermocycling of a sample (e.g., to provide a portion of the preparation process in PCR testing).

In some embodiments, transportation of fluidic droplets on the cartridge surface can be controlled by a controller and/or other computing devices to create a programmable fluidic path which can be used in number of ways (e.g., to facilitate the performance of an assay and/or immunoassay). To do so, the controller and/or other computing devices may use one or more forces (e.g., electromechanical forces) created via one or more components (e.g., a plurality of electrodes) in the cartridge to create one or more gates and/or barriers to impede and/or allow transportation of a droplet along one or more channels or paths of the cartridge. Additionally, although the gates described herein are primarily described as electromechanical gates that include one or more electrodes, one or more of these gates may include more or different components and/or include more or different functionalities. For example, in some embodiments, one or more of these gates may include a mechanical gate (e.g., a barrier gate, a membrane gate), an electromechanical gate, and/or an electrical gate, among other possibilities.

Furthermore, this transportation may be aided by one or more other forces, including gravitational forces, via tipping and/or tilting the cartridge in one or more directions and/or along one or more axes of the cartridge. In examples, the controller and/or other computing devices may create an incline in one or more directions to impede and/or allow transportation of a droplet along one or more channels or paths of the cartridge. Further, because the fluidic movements of the droplets are controlled by a controller and/or other computing device, and programmable, assay protocols and subparts thereof can be finely controlled to meet the needs of the desired testing protocol (e.g., an assay).

In some embodiments, it is beneficial to protect or otherwise shield the droplet, components thereof, and/or other materials residing on the surface of the cartridge for one or more steps in an assay. To do so, in some embodiments, the cartridge may be covered by one more materials that protect the components residing on the surface of the cartridge, but still leave enough space on the cartridge surface for the droplet, components thereof, and/or other assay components to be transported and/or immobilized on the cartridge surface. In some example embodiments, this protective layer may be made of plastic and/or other materials that do interact with the droplet and/or components thereof, electrodes, or any other controller and/or other computing devices during the assay protocols and subparts thereof.

In an example embodiment, in addition to manipulating (e.g., transporting and/or immobilizing) the droplet on the surface of the cartridge, various antibodies, antigens, and/or other components may also be controlled, mixed, transported, and/or immobilized on the surface of the cartridge. Using this programmable protocol, antibodies, antigens, and/or other components may be adhered onto one or more surfaces of a plurality of particles (the “assembled particles”). In a further aspect, one or more analyses may be performed on the assembled particles (or other particles) on the surface of the cartridge. In this regard, a user of the cartridge can perform complicated, often multi-step protocols, which are often spread over several machines and devices at various stages of the multi-step protocols, in a single cartridge and a single instrument/device. In one example embodiment, a multiplex multiple analyte targets in a single reaction may be performed on a droplet on the surface of the cartridge detailed above, instead of using multiple devices (e.g., shaker plates, pipettes, vials, plates with multiple wells, plate readers, cameras, etc.). In one example embodiment, a multiplex multiple analyte targets in a single reaction may be performed on a droplet in a portion of the surface of the cartridge comprising a single electrode.

In this regard, by combining the cartridge, EWOD, gravitational forces, and automated (or substantially automated) tip/tilt cartridge manipulation technologies, the concepts described herein provide disclosure for a compact, in clinic, instrument with multiplex capability. In an example embodiment, by leveraging these technologies, a platform is described that can have the same convenience as other tabletop devices (e.g., a SNAP® reader and device) but with the increased menu of capabilities for laboratory testing and assay protocols, including multi-part assays (e.g., multiplex, Mpx lab tests), without the inconvenience and costs of the devices, instruments, and operators typically required for these tests and assays (e.g., liquid handling robots, plates, plate washers, and/or specialized plate readers). Further, in example embodiments, because multiple tests and assays may be completed on one or more small sample sizes (e.g., via several different testing protocols in different channels of the cartridge disclosed herein), the present disclosure allows complex analysis (e.g., of multiple analytes) according to several different, discrete testing protocols, all based on small volumes of samples and in a single cartridge, which is beneficial in instances where sample volume and/or time to result is an issue.

In one example, a user may add a sample (e.g., a fecal sample, urine sample, blood sample, etc.) into a reservoir of the cartridge, insert a cartridge into a tabletop instrument/device, and allow the instrument/device to add and/or control other components (e.g., assembly particles, buffer solutions, wash solutions, reagents, detection fluids, antibodies, etc.) on the cartridge, and analyze one or more components to provide one or more results to clinician, physician, and/or patient based on the same, all using the same sample, cartridge and instrument/device. Importantly, once the user inserts the cartridge into the tabletop instrument device, some (or all) of the fluidics, manipulation of the components in the cartridge, and eventual reading of these components are all automated, controlled, and finely-tuned by program instructions executing on a computing device, all of which may be accomplish without user interaction or control.

By doing so, several benefits are realized, including users (e.g., clinicians) having the same high throughput/multiplexing capability of the traditional technologies without the required overhead of user controlling or coordinating every step of the process or the multitude of separate devices and components required to accomplish the tests and/or assays. Time to result would also be improved, instead of sending samples to a lab and waiting for a prolonged period of time for results (sometimes several days), users could have results in a matter of minutes, and all while using a single sample on a single cartridge in connection with a single device. This improved time to result also improves the ability for a treating physician and/or patient to receive results in a more timely manner (e.g., results could be shared with the patient during the visit) and make more timely decisions based thereon.

In a further aspect, by allowing bi-directional flow along a series of separate linear paths of the one or more channels on the surface of the cartridge, results from sample interaction with the particles that are used in the testing protocols are also improved. In one example, particles may be immobilized along one or more portions of the path on the cartridge surface (e.g., at or proximate to the tip axis of the cartridge) and a sample or samples may be transported along the path and interact with the particles more than once, potentially at different stages of the testing protocol. In this regard, sample analysis and associated testing protocols are improved as particle/sample interactions are increased. In example, with increased particle/sample interaction, any associated particle assembly and/or associated readings/imaging/analysis are also improved.

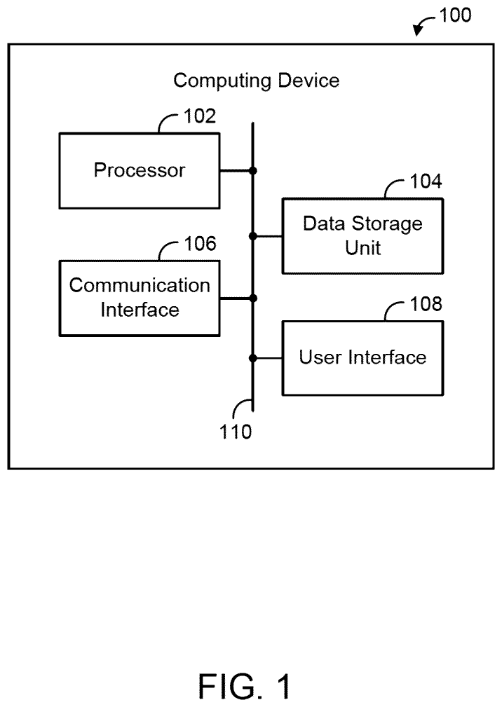

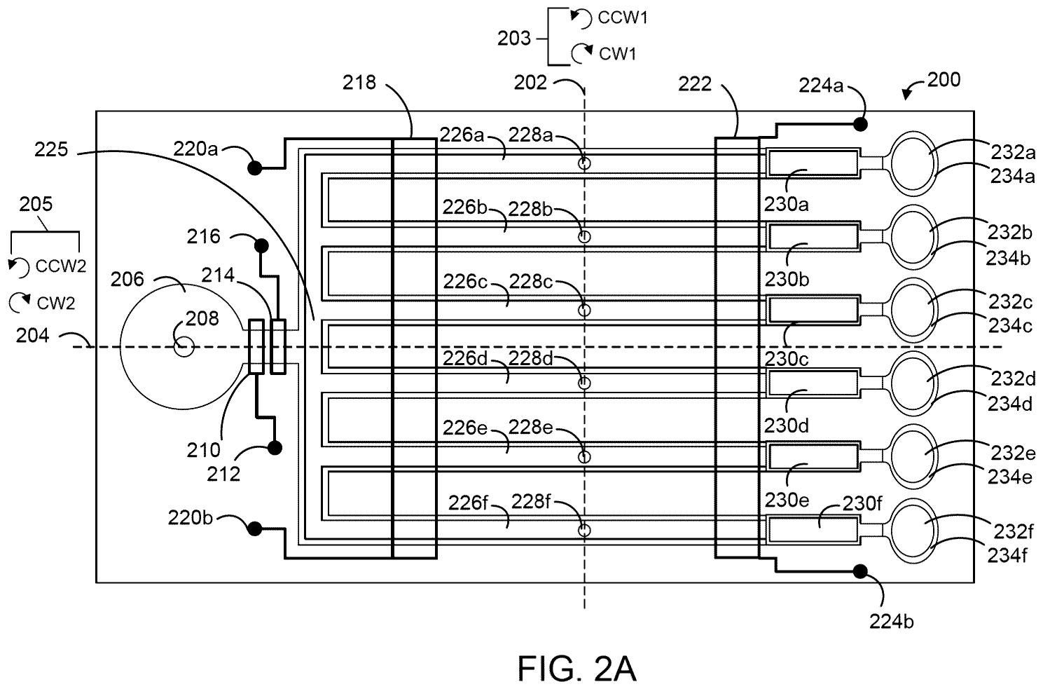

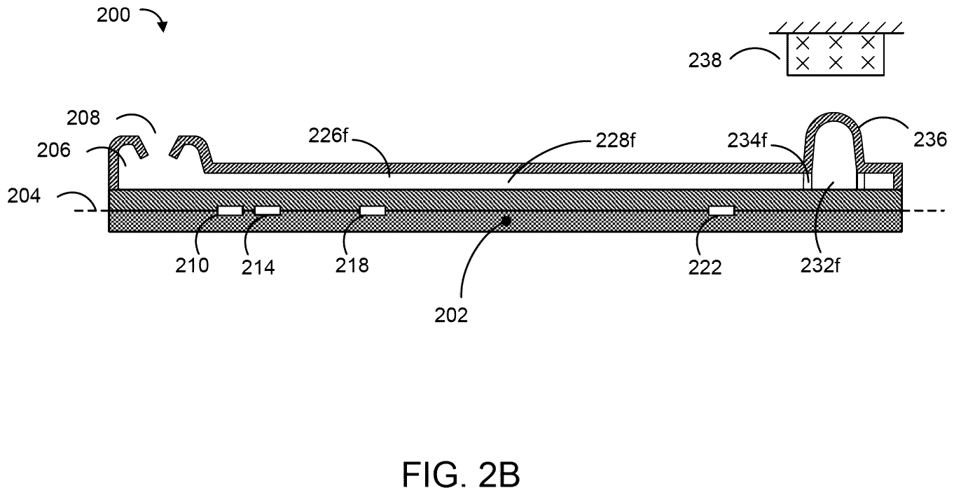

Referring now to the figures, FIG. 1 is a simplified block diagram of an example computing device 100 of a system (e.g., that can be utilized with devices and methods illustrated in FIGS. 2A-4, described in further detail below). Computing device 100 can perform various acts and/or functions, such as those described in this disclosure. Computing device 100 can include various components, such as processor 102, data storage unit 104, communication interface 106, and/or user interface 108. These components can be connected to each other (or to another device, system, or other entity) via connection mechanism 110. Processor 102 can include a general-purpose processor (e.g., a microprocessor and/or a central processing un it (CPU)) and/or a special-purpose processor (e.g., a digital signal processor (DSP) and/or a graphics processing unit (GPU)).

Data storage unit 104 can include one or more volatile, non-volatile, removable, and/or non-removable storage components, such as magnetic, optical, or flash storage, and/or can be integrated in whole or in part with processor 102. Further, data storage unit 104 can take the form of a non-transitory computer-readable storage medium, having stored thereon program instructions (e.g., compiled or non-compiled program logic and/or machine code) that, when executed by processor 102, cause computing device 100 to perform one or more acts and/or functions, such as those described in this disclosure. As such, computing device 100 can be configured to perform one or more acts and/or functions, such as those described in this disclosure. Such program instructions can define and/or be part of a discrete software application. In some instances, computing device 100 can execute program instructions in response to receiving an input, such as from communication interface 106 and/or user interface 108. Data storage unit 104 can also store other types of data, such as those types described in this disclosure.

Communication interface 106 can allow computing device 100 to connect to and/or communicate with another other entity according to one or more protocols. In one example, communication interface 106 can be a wired interface, such as an Ethernet interface or a high-definition serial-digital-interface (HD-SDI). In another example, communication interface 106 can be a wireless interface, such as a cellular or WI FI interface. In this disclosure, a connection can be a direct connection or an indirect connection, the latter being a connection that passes through and/or traverses one or more entities, such as a router, switcher, or other network device. Likewise, in this disclosure, a transmission can be a direct transmission or an indirect transmission.

User interface 108 can facilitate interaction between computing device 100 and a user of computing device 100, if applicable. As such, user interface 108 can include input components such as a keyboard, a keypad, a mouse, a touch sensitive panel, a microphone, a camera, and/or a movement sensor, all of which can be used to obtain data indicative of an environment of computing device 100, and/or output components such as a display device (which, for example, can be combined with a touch sensitive panel), a sound speaker, and/or a haptic feedback system. More generally, user interface 108 can include hardware and/or software components that facilitate interaction between computing device 100 and the user of the computing device 100.

Computing device 100 can take various forms, such as a workstation terminal, a desktop computer, a laptop, a tablet, a mobile phone, or a controller.

Now referring to FIGS. 2A-2B, a cartridge 200 for preparing and testing a sample is depicted, according to an example embodiment. Namely, FIG. 2A illustrates a top-down view of the cartridge 200. FIG. 2B illustrates a cross-sectional view of the cartridge 200.

Now referring to FIG. 2A, cartridge 200 includes a tip axis 202, a tilt axis 204, a sample reservoir 206, a sample port 208, a sample gate 210 connected to a first electrode 212, a metering gate 214 connected to a second electrode 216, a channel gate 218 connected to a first pair of electrodes 220a and 220b, a reagent gate 222 connected to a second pair of electrodes 224a and 224b, and a plurality of channels 226a-226f extending from the sample reservoir 206. While in the embodiment depicted in FIG. 2A the tip axis 202 appears to bisect the cartridge 200 in one direction and the tilt axis 204 appears to bisect the cartridge 200 in another direction, it should be understood that this is merely exemplary.

Further, although first pair of electrodes 220a and 220b and second pair of electrodes 224a and 224b are illustrated as pairs of electrodes in FIG. 2A, in embodiments only one electrode may be required to toggle channel gate 218 and/or reagent gate 222, respectively—although a pair of electrodes may increase reliability of connection between the electrodes and channel gate 218 and/or reagent gate 222. Moreover, while in the embodiment depicted in FIG. 2A, pairs of electrodes are depicted controlling the channel gate 218 and the reagent gate 222, the channel gate 218 and/or the reagent gate 222 may be controlled by more than two electrodes, and can be controlled by any suitable number of electrodes. As also illustrated in FIG. 2A, in an example embodiment, each channel of the plurality of channels 226a-226f includes a respective analysis location (illustrated in FIG. 2A as 228a-228f), a respective reagent reservoir (illustrated in FIG. 2A as 230a-230f) and a respective detection reservoir (illustrated in FIG. 2A as 232a-232f), each of which includes a respective barrier (illustrated in FIG. 2A as 234a-234f) in each respective detection reservoir.

In example embodiments, sample gate 210 may be used to transport a first fluidic volume of the sample from the sample reservoir 210 utilizing one or more electrodes, including first electrode 212. In examples, metering gate 214 may be used to transport a second fluidic volume (e.g., a predetermined portion of the first fluidic volume) from the sample gate 210 utilizing one or more electrodes, including first electrode 212 and/or second electrode 216. In some examples, if the first volume of the sample, the second volume of the sample, or both, need to undergo further mixing and/or agitation events, the sample gate 210 and/or the metering gate 214 may be selectively engaged (e.g., rapidly closed, opened, and closed again) to promote such fluid manipulation, along with other forces that may act on the fluidic samples on the surface of the cartridge, including gravitational forces created by, for example, tipping and/or tilting the cartridge around tip axis 202 and/or tilt axis 204. Other examples are possible.

In examples, once a volume of the sample has been dispensed into the sample reservoir 206, rotation of the cartridge 200 around the tip axis 202 moves the sample from the sample reservoir 206 the channel head 225 of channels 226a-226f and, in combination with rotation around the tilt axis 204 and/or utilization of channel gate 218 and/or reagent gate 222, ultimately into one or more of channels 226a-226f, one or more analysis locations 228a-228f, one or more of reagent reservoirs 230a-230f, and/or one or more detection reservoirs 232a-232f, through gravitational and electromechanical forces.

According to an example embodiment, the cartridge 200 is arranged such that during testing, the cartridge can rotate with respect to the tip axis 202 (e.g., in a clockwise direction (CW1) or a counter-clockwise direction (CCW1), as illustrated in tip axis rotation indicator 203) and/or the tilt axis 204 (e.g., in a clockwise direction (CW2) or a counterclockwise direction (CCW2), as illustrated in tilt axis rotation indicator 205) to sequentially transport a fluidic sample, and the cartridge 200 can open and close the illustrated gates (e.g., activate and deactivate the illustrated gates) and/or move the illustrated barriers to allow and/or inhibit fluidic communications between the channels and the reservoirs. For instance, one or more of the sample gate 210 and/or the metering gate 214 may be activated and/or deactivated to allow a fluidic sample to be transported via gravitational forces created by tipping the cartridge via rotation around the tip axis 202 to cause fluidic communication between the sample reservoir 206 and one or more of channels 226a-226f. In another example, the channel gate 214 may be deactivated (e.g., moved from a closed position in which fluid flow through the channel gate 214 is restricted, to an open position) to allow a fluidic sample to be transported via gravitational forces created by tipping the cartridge via rotation around the tip axis 202 in direction CW1 to cause fluidic communication along one or more of channels 226a-226f, including over one or more of the analysis locations 228a-228f. In another example, the fluidic sample may be transported in an opposing direction via gravitational forces created by tipping the cartridge via rotation around the tip axis 202 in the CCW1 direction. In a further aspect, in examples, the channel gate 214 may then be reactivated (e.g., moved from an open position, to a closed position in which fluid is restricted from flowing through the channel gate 214) to inhibit mixing of the fluidic sample and one or more reagents stored in reagent reservoirs 230a-230f as reagent gate 222 is deactivated (e.g., moved from a closed position in which fluid is restricted from flowing through the reagent gate 222, to an open position) to allow one or more reagents to be transported via gravitational forces created by tipping the cartridge in the CCW1 direction via rotation around the tip axis 202 to cause fluidic communication of the one or more reagents along one or more of channels 226a-226f, including over one or more of the analysis locations 228a-228f. In yet another example, one or more of barriers 234a-234f between the channel and the detection reservoir can be moved to provide fluidic communication between the channel, the reagent reservoir, and the detection reservoir. This allows the sample to sequentially mix with the reagent and the detection fluid to prepare the sample for testing (e.g., imaging) at the one or more of the analysis locations 228a-228f. In example embodiments, a controller (e.g., such as computing device 100) may be used to activate and deactivate the illustrated gates and/or move the illustrated barriers to allow and/or inhibit fluidic communications between the channels and the reservoirs to prepare and contain the sample for testing and/or imaging. Further, as illustrated in FIG. 2A, the plurality of channels, reagent reservoirs, detection reservoirs, and testing locations allow for multiple tests to be performed on a sample at once.

As noted above, the cartridge includes sample reservoir 206 which, in some examples, is located at a first end of cartridge 200. The sample reservoir 206 is configured to receive the sample, including via sample port 208. In some examples, the sample reservoir 206 can include an on-board buffer to prevent pH fluctuations in the sample. Example buffers can include, but are not limited to Phosphate-buffered saline (PBS), Tris-buffered saline (TBS), Hanks' Balance Salt Solution (HBSS), and/or glycerol-based cryopreservation buffer.

In example embodiments, the sample reservoir includes a sample port 208. The sample port 208 is positioned above the sample reservoir 206 allowing a user to deposit the sample into the sample reservoir 206. In some examples, the sample port 208 has a small diameter to prevent loss of the sample as the cartridge 200 tips and/or tilts about the tip axis 202 and/or tilt axis 204.

In examples, the cartridge 200 also includes a plurality of channels 226a-226f extending in a substantially linear direction from the sample reservoir 206. The plurality of channels 226a-226f are in fluidic communication with the sample reservoir 206 so that when one or more of the sample 210 and/or the metering gate 214 is deactivated and cartridge 200 is rotated around both the tip and tilt axes, the sample moves from the sample reservoir 206 into one of the plurality of channels 226-226f via a gravitational force.

In some examples, by rotating the cartridge 200 around the tip and/or tilt axes, one or more of the plurality of channels 226a-226f and/or the channel head 225 is inclined (i.e., has a surface on an inclined plane). For instance, in embodiments, the tip axis 202 is transverse to the channels 226a-226f. Accordingly, by rotating the cartridge 200 in the CW1 direction around tip axis 202, the channels can be higher in a vertical direction towards the end where the sample reservoir 206 is located and lower in the vertical direction towards the end where the reagent and detection reservoirs are located, thereby causing the liquid sample to move towards the end where the reagent and detection reservoirs are located due to gravitational forces. As shown in the top-down view of cartridge 200 of FIG. 2A, this rotation would cause the liquid sample to move from the left end of the illustrated cartridge 200 towards the right end of the cartridge 200. Conversely, in examples, rotating cartridge 200 in the CCW1 direction around tip axis 202 would cause the liquid sample to move from the right end of the illustrated cartridge 200 towards the left end of the cartridge 200.

In embodiments, the tilt axis 204 is transverse to the tip axis 202. In a further aspect, by rotating the cartridge 200 in the CW2 direction around tilt axis 204, one or more of the channels on a first side of tilt axis 204 (e.g., channels 226a-226c) can be lower and higher on a second side of tilt axis 204 (e.g., channels 226d-226f), thereby causing the liquid sample to move towards the first side of tilt axis 204 (e.g., into channels 226a-226c) due to gravitational forces. As shown in the top-down view of cartridge 200 of FIG. 2A, this rotation would cause the liquid sample to move from the bottom end of the illustrated cartridge 200 towards the top end of the cartridge 200. Conversely, in examples, rotating cartridge 200 in the CCW2 direction around tilt axis 204 would cause the liquid sample to move from the top end of the illustrated cartridge 200 towards the bottom end of the cartridge 200. Other examples are possible.

In example implementations, these gravitational forces can be used to drive the sample around the cartridge when inclined around tip axis 202, and/or tilt axis 204 to help facilitate a number of tests-particularly when utilized in connection with illustrated gates and/or barriers. For example, immunoassays may require a back and forth washing motion over immobilized particles (e.g., adhered to and/or otherwise located at one or more of the analysis locations 228a-228f. In these examples, different rotational angles can be used to iteratively transport the sample up back and forth along channels 208a-208f to sequentially prepare the sample and assemble one or more associated particles for testing at one or more of the analysis locations 228a-228f.

In some examples, the one or more channels 226a-226f can include a plurality of particles. In examples, the plurality of particles can reside and/or be adhered to a surface of one or more of the plurality of channels 226a-226f. In examples, these particles may comprise one or more materials, including one or more of the following: glass, polymers, polystyrene, latex, elemental metals, ceramics, metal composites, metal alloys, silicon, or of other support materials such as agarose, ceramics, glass, quartz, polyacrylamides, polymethyl methacrylates, carboxylate modified latex, melamine, and Sepharose, and/or one or more hybrids thereof. In particular, useful commercially available materials include carboxylate modified latex, cyanogen bromide activated Sepharose beads, fused silica particles, isothiocyanate glass, polystyrene, and carboxylate monodisperse microspheres. Furthermore, these particles also comprise one or more specific shapes, dimensions, and/or configurations and may be modified for one or more specific uses. For example, these particles may be a variety of sizes from about 0.1 microns to about 100 microns, for example about 0.1, 0.5, 1.0, 5, 10, 20, 30, 40 50, 60, 70, 80 90 or 100 microns. The plurality of particles can also contain one or more identifying features (such as a unique bar code, a responsive wavelength, a color, a shape, an alphanumeric symbol, and/or the like) that can be detected independent of a signal associated with the presence of analyte. By utilizing the plurality of independently-detectable particles (e.g., bar-coded beads), a user can perform multiple tests at once to detect a number of different analytes. In a further aspect, these particles may be surface modified and/or functionalized with biomolecules for use in biochemical analysis. The particles of the disclosure may also be used in various homogenous, sandwich, competitive, or non-competitive assay formats to generate a signal that is related to the presence or amount of an analyte in a test sample.

In a further aspect, in example embodiments, the plurality of particles may be introduced into a droplet, either in a liquid suspension or dried onto a surface of the cartridge 200 and rehydrated. In one example, the plurality of particles may be suspended in buffer solution containing sucrose, removed from the suspension, and dried before being stored on one or more analysis locations 228a-228f of the cartridge surface. In examples, the dried plurality of particles may be rehydrated with one or more solutions containing one or more components (e.g., reagents, sample, or both, among other possibilities) before being used in one or more aspects of a testing protocol (e.g., an assay). In example embodiments, once the plurality of particles are rehydrated and/or introduced into a fluidic droplet, the droplet containing the plurality of particles may be transported between one or more portions of the cartridge surface to be introduced into one or more steps of the particle assembly and/or testing protocol (e.g., to be mixed with a sample residing in sample reservoir (e.g., a fecal sample, urine sample, blood sample, etc.)). Other examples are possible.

In example embodiments, the plurality of channels 226a-226f include and/or are adjacent to one or more reagent reservoirs. In some examples, each of the plurality of channels 226a-226f includes a corresponding reagent reservoir of reagent reservoirs 230a-230f. In examples, each reagent reservoir can include one or more on-board reagents to prepare the sample for testing. In examples, the reagents can include one or more of: (i) a binding reagent; (ii) a wash reagent; (iii) a conjugate reagent; (iv) a fluorescent stain; (v) markers; (vi) transport (e.g., oil); (vii) or beads. In examples, although not illustrated in FIG. 2A, one or more of the channels may include a second reagent reservoir that may contain one or more additional and/or alternative reagents. For example, a first reagent reservoir in a channel can include a binding reagent, while a second reagent reservoir can include a wash reagent, or vis versa. Many example combinations of reagents are possible.

In example embodiments, each of the six reagent reservoirs of FIG. 2A can include different on-board reagents suitable for performing different tests on the sample at once. For instance, each reagent reservoir can include a different reagent used to prepare the sample to be tested for analytes that can be detected in samples as a result of a binding assay, typically an immunoassay. Example tests can include the determination of a vast variety of analytes know in the art to be detectable by, for example, immunoassay, including, but are not limited to: (i) PCR, (ii) Anaplasma, (iii) Ehrilichia, (iv) heartworm, (v) Lyme disease, (vi) Feline Immunodeficiency Virus (FIV), (vii) Feline leukemia virus (FeLV), (viii) Giardia, (ix) Parvo, (x) Lepto, (xi) hookworm, (xii) roundworm, (xiii) whipworm, (xiv) tapeworm, (xv) cystoisospora, (xvi) campylobacter jejuni, (xvii) cryptosporidium, (xviii) enteric coronavirus, (xix) salmonella, or (xx) tritrichromonas. For example, in an example implementation, reagent reservoir 230a can include include reagents suitable for an Anaplasma test, reagent reservoir 230a can include reagents suitable for an Ehrilichia test, reagent reservoir 230b can include reagents suitable for a heartworm test, reagent reservoir 230c can include reagents suitable for a Lyme disease test, reagent reservoir 230d can include reagents suitable for a FIV test, reagent reservoir 230e can include reagents suitable for a FELV test, and reagent reservoir 230f can include reagents suitable for a PCR test. In example embodiments, PCR detection may include detection of common infectious pathogens, including diarrhea pathogens: (1) Parvovirus/Panleukopenia; (2) Campylobacter jejuni; (3) Cryptosporidium spp.; (4) Enteric Coronavirus; (5) Giardia spp.; (6) Salmonella spp.; and (7) Tritrichomonas blagburni, among others. Many example combinations of tests are possible.

Although the example cartridge 200 shown in FIGS. 2A-2B, includes six channels 226a-226f, six reagent reservoirs 230a-230f, and six detection reservoirs 232a-232f, many different configurations are possible. For instance, in some examples, the cartridge 200 may include fewer channels (e.g., 1, 2, 3, 4, or 5), each with its own respective reagent and/or detection reservoir. Alternatively, in some examples, the cartridge 200 can include more channels (7, 8, 9, 10, etc.), each with its own respective reagent and/or detection reservoir. Many example configurations are possible.

Further, each channel includes a respective analysis location 228a-228f and a respective detection reservoir of detection reservoirs 232a-232f. In examples, the detection reservoirs 232a-232f are located at a second end of the cartridge 200, near the perimeter of the cartridge 200 distal from the sample reservoir, so that the sample can travel through the channels, and mix and/or otherwise interact with the components in the reagent reservoirs before interacting with the components of the detection reservoirs.

In example implementations, the detection reservoirs 232a-232f include one or more on-board detection fluids. In some examples, the detection fluid can include, but is not limited to one more fluorescent stains, Tetramethylbenzidine (TMB), fluorescein (FAM), Tetramethylrhodamine (TAMRA), Hexachlorofluorescein (HEX), Jun proto-oncogene (JUN), Cyanine Dye 5 (Cy5), and Cyanine Dye 5.5 (Cy5.5).

In examples, the analysis locations 228a-228f can include a plurality of particles. In examples, the plurality of particles can be adhered to a surface of the analysis locations 228a-228f to allow assembly and/or testing (including imaging) over multiple channels in a centralized location of the cartridge (e.g., along the tip axis). The plurality of particles can contain one or more identifying features (such as a unique bar code, a responsive wavelength, a color, a shape, an alphanumeric symbol, and/or the like) that can be detected independent of a signal associated with the presence of analyte. By utilizing the plurality of independently-detectable particles and/or beads, the cartridge 200 can perform multiple tests at once to detect a number of different analytes, all along a centralized location of the cartridge.

In examples where different tests are being performed on the sample at once, the detection reservoir can include detection fluid suitable for the corresponding test. For example, if reagent reservoir 230a includes reagents suitable to prepare the sample for a heartworm test, detection reservoir 232a can include a detection fluid suitable for a heartworm test. And, if reagent reservoir 230b include reagents suitable to prepare the sample for an Anaplasma test, detection reservoir 232b can include detection fluid suitable for an Anaplasma test. Many examples are possible.

In example embodiments, once the plurality of particles are assembled and/or otherwise prepared for testing, the cartridge may be returned to a substantially flat position to minimize any further fluidic transportation prior to testing. The flat surface helps to facilitate retaining the sample and/or assembled particles, such that once the prepared sample and/or assembled particles are ready for testing and have reached the analysis locations 228a-228f, there is no further transportation or mixing with other components (e.g., previously-used wash fluid). Further, once the sample is prepared and the cartridge 200 is no longer rotating, the sample and/or assembled particles can be imaged in any one or more of the analysis locations 228a-228f. Further, a flat surface may help to distribute the sample and/or assembled particles in an even layer (e.g., having a consistent depth) across any one or more of the analysis locations 228a-228f. Additionally, in example implementations, any one or more of the analysis locations 228a-228f can include optically transparent materials suitable for imaging and/or observation.

In some examples, there may be a visual indication of a testing result. For instance, the detection fluid may turn a certain color to indicate a positive result or negative testing result of a particular test. In another example, a visual indication may not be detectable to the human eye, such as a fluorescent stain. In these examples, a user may utilize an imaging device and/or an optical reader to help determine a testing result. Many examples are possible as are known in the immunoassay arts.

As illustrated in FIG. 2A, cartridge 200 includes a series of gates and barriers corresponding to the six illustrated channels 226a-226f. Namely, series of gates and barriers in cartridge 200 are configured to separate (e.g., prevent fluidic communication between) respective reservoirs and/or channels during different portions of preparing the sample for testing. In this manner, in examples, the respective portions of the sample can be introduced into one or more channels, and respective reagents and detection fluids can be introduced to one or more respective sample, all in a sequential manner. Specific activation, deactivation, and reactivation of these gates, as well as displacing the barriers, shown in FIGS. 2A-2B are described in the paragraphs below.

In example embodiments, once a sample is added to the sample reservoir 206 via sample port 208, the sample gate 210 and/or the metering gate 214 can be used to measure and/or withdraw a specific volume of the sample (and in some examples, a buffer) using the first electrode 212 and/or second electrode 216.

In example embodiments, the cartridge can then be tipped and/or tilted along tip axis 202 and/or tilt axis 204 to enter the channel head 225 and ultimately be transported into a particular channel. For example, by rotating the cartridge in a first direction around the tip axis 202, the sample may be transported into the channel head 225, and then by rotating the cartridge in a second direction around the tilt axis 204, the sample may be transported along the channel head 225 and into channel 226a. In examples, this sequence, including measuring and withdrawing volumes of the sample, may be repeated several times to transport samples to a first particular location of any, some, or all of the illustrated channels 226a-226f.

In a further aspect, in examples, during this transportation of the sample to each of the channels, channel gate 218 may be closed to impede the transportation of the any of the sample volumes into a second particular portion of the respective channel, including to the analysis locations 228a-228f. As used herein, the terms “opening” and “closing” one or more gates refers to energizing (toggling open) and de-energizing (toggling closed) the one or more gates, respectively. In a further aspect, in example embodiments, one or more portions of a surface of the cartridge that is proximate to and/or above an electrode may be hydrophobic and/or has a very high contact angle) (>90° so that fluid will not normally move onto that portion of the surface. In these examples, closing a gate via one or more electrodes comprises a “de-energized” electrode state and opening a gate via one or more electrodes comprising charging the electrode with voltage (energizing the electrode) such that one or more droplets (e.g., sample droplets) are able to overcome the hydrophobicity of the surface and move to be positioned above the electrode (e.g., by reducing contact angle to be <90° so the droplet acts as if it is contacting a hydrophilic surface). Additionally, during this transportation of the sample to each of the channels, the reagent gate 222 may be closed (de-energized) to separate the plurality of channels 226a-226f from the contents of reagent reservoirs 230a-230f.

In example embodiments, once all the samples are transported to each of the channels, the channel gate 218 may be opened, while the reagent gate 222 remains toggled closed, to allow the samples to be transported to and along into the second portion of the respective channel, including to the analysis locations 228a-228f. In a further aspect, in examples, the cartridge 200 can then be tipped back and forth, in opposing directions, along tip axis 202 to allow the samples to be transported over the analysis locations 228a-228f, potentially multiple times. As described above, one or more of these analysis locations 228a-228f may contain one or more particles (e.g., bound captured antibodies) and/or chemical indicators, one or more of which may interact with the sample as it is transported over the analysis location of a particular channel, potentially multiple times. In examples, once the samples have sufficiently interacted with the components stored at the analysis locations 228a-228f, the samples may be transported back into the first portion of a particular channel and/or channel head 225, and then channel gate 218 may be toggled closed to ensure the sample remains in that first portion of a particular channel and impede the sample from reentering the second portion of a particular channel.

In example embodiments, reagent gate 222 may then be opened to allow the transportation of the any of the contents of the reagent reservoirs 230a-230f (e.g., one or more reagents) into the second portion of the respective channel, including to the analysis locations 228a-228f. Additionally, during this transportation of the contents of the reagent reservoirs 230a-230f to each of the channels 226a-226f, the barriers 234a-234c separate the contents of the detection reservoirs 232a-232f from the reagent reservoirs 230a-230f, and ultimately, the plurality of channels 226a-226f from the contents of reagent reservoirs 230a-230f.

In a further aspect, in examples, the cartridge 200 can then be tipped back and forth, in opposing directions, along tip axis 202 to allow the contents of reagent reservoirs 230a-230f to be transported over the analysis locations 228a-228f, potentially multiple times. As described above, one or more of these analysis locations 228a-228f may contain one or more particles (e.g., bound captured antibodies) and/or chemical indicators, one or more of which may interact with the contents of reagent reservoirs 230a-230f as they are transported over the analysis location of a particular channel, potentially multiple times. In examples, once the contents of reagent reservoirs 230a-230f have sufficiently interacted with the components stored at the analysis locations 228a-228f, reagent gate 222 may be closed again and channel gate 218 may be opened while the contents of reagent reservoirs 230a-230f are in the second portion of the channel, and then the contents of reagent reservoirs 230a-230f may be transported into the first portion of a particular channel and/or channel head 225 (e.g., by tipping the cartridge in that direction). In a further aspect, in examples, the channel gate 218 may then be closed to ensure the contents of reagent reservoirs 230a-230f remain in the first portion of the respective channel and impede the contents of reagent reservoirs 230a-230f from reentering the second portion of the respective channel.

After the sample and contents of reagent reservoirs 230a-230f are impeded from reentering the second portion of a respective channel via channel gate 218, movement of barriers 234a-234f allows fluidic communication between the channels 226a-226f and the detection reservoirs 232a-232f. Additionally, movement of barriers 234a-234f allows fluidic communication between the detection reservoirs 232a-232f and the reagent reservoirs 230a-230f. In some examples, one or more of barriers 234a-234f include a compressible material that, when compressed, causes movement of the barrier. In some examples, one or more of the barriers 234a-234f include compliant material, such as LLDPE, LDPE, or foil, although other example materials are possible. In examples, application of a force and/or compression of the barriers 234a-234f can cause movement, fracture, plastic deformation, or elastic deformation of the barriers 234a-234f to allow fluidic communication of the contents of detection reservoirs 232a-232f into a respective channel by fluidic forces. Further, in examples, such application of a force and/or compression of the barriers 234a-234f may be due to a user and/or an actuator compressing the individual barrier. Many configurations are possible.

For example, although not specifically illustrated in FIG. 2A, an additional gate (e.g., a detection gate) similar to channel gate 218 and reagent gate 222, might be implemented between the reagent reservoirs 230a-230f and detection reservoirs 232a-232f, and used to manipulate fluid transportation and/or control one or more components of the cartridge components and/or sequences for controlling the same, as described herein.

In a further aspect, in examples, the cartridge 200 can then be tipped back and forth, in opposing directions, along tip axis 202 to allow the contents of detection reservoirs 232a-232f to be transported over the analysis locations 228a-228f, potentially multiple times. As described above, one or more of these analysis locations 228a-228f may contain one or more particles (e.g., bound captured antibodies) and/or chemical indicators, one or more of which may interact with the contents of detection reservoirs 232a-232f as they are transported over the analysis location of a particular channel, potentially multiple times. In examples, once the contents of detection reservoirs 232a-232f have sufficiently interacted with the components stored at the analysis locations 228a-228f, channel gate 218 may be opened while the contents of the detection reservoirs 232a-232f are in the second portion of the channel, and then the contents of detection reservoirs 232a-232f may be transported into the first portion of a particular channel and/or channel head 225 (e.g., by tipping the cartridge in that direction). In a further aspect, in examples, the channel gate 218 may then be closed to ensure the contents of detection reservoirs 232a-232f remain in the first portion of the respective channel and impede the contents of detection reservoirs 232a-232f from reentering the second portion of the respective channel.

Once the samples and/or assembled particles are prepared and located at the analysis locations 228a-228f, the cartridge 200 may be rotated back to a level plane such there are few or no inclined surfaces during testing of the samples and/or assembled particles.

Now referring to FIG. 2B, FIG. 2B illustrates a cross-sectional view of the cartridge 200. As illustrated in FIG. 2B, cartridge 200 includes a tip axis 202, a tilt axis 204, a sample reservoir 206, a sample port 208, a sample gate 210, a metering gate 214, a channel gate 218, and a reagent gate 222. As also illustrated in this view of cartridge 200, cartridge 200 includes channel 226f, which extends from the sample reservoir 206, and includes analysis location 228f, reagent reservoir 230f, and detection reservoir 232f, which includes barrier 234f and compressible material 236. As also illustrated in FIG. 2B, the compressible material 236 of detection reservoir 232f and barrier 234f may interact with an actuator 238, which can cause compression of barrier 234f and detection reservoir 232f, thereby allowing fluid communication of the contents of detection reservoir 232f into channel 226f. In examples, actuator 238 may apply pressure to the compressible material 236 of detection reservoir 232f and barrier 234f and cause the barrier 234f to rupture and allow the contents of the detection reservoir 232f to transport into the channel 226f. In examples, actuator 238 may apply pressure to the compressible material 236 by remaining stationary as the cartridge rotates around tip axis 202, causing the compressible material 236 to interface with and/or be compressed by the actuator. In some examples, actuator 238 may apply pressure to the compressible material 236 by applying pressure to the compressible material 236 (e.g., via a downward piston actuation) as the cartridge 200 remains stationary. Many examples are possible.

Additionally or alternatively, although not specifically illustrated in FIGS. 2A-2B, different temperature zones can be created along the cartridge 200 to facilitate thermocycling. As noted above, PCR testing involves thermocycling the sample to promote amplification, and thereby detection, of one or more target sequences in the sample. In example embodiments, performing this thermocycling may be accomplished by configuring various portions of the cartridge to perform one or more heating functions required for thermocycling the sample. For instance, in some example embodiments denaturation of the sample may occur in a first temperature zone (e.g., at approximately 95° C.), annealing of the sample may occur in a second temperature zone (e.g., at approximately 60° C.), and elongation of the sample may occur in a third temperature zone (e.g., at approximately 72°° C.). In some examples, one or more of the first, second, and third temperature zones may be different portions of the cartridge. In some examples, one or more of the first, second, and third temperature zones may be the same or similar portions of the cartridge. In the example embodiments, a first temperature zone (e.g., at approximately 95° C.) may occur proximate to the sample reservoir 206, a second temperature zone (e.g., at approximately 60° C.) may occur proximate to the detection reservoirs 232a-232f, and a third temperature zone (e.g., at approximately 72° C.) may occur proximate to the tip axis 202 and analysis locations 228a-228f. In these examples, these temperature zones may correspond to the different phases of PCR testing (i.e., denaturation, annealing, and elongation). Other configurations are possible.

In some example embodiments, to achieve a temperature differential (i.e., temperature zones), a heat source (e.g., conductive, radiative, infrared, and/or laser heat sources and/or screen printed conductive inks deposited on an underside of the bottom plate producing resistive heat) can be above or below the cartridge 200. Different example configurations are possible based on the position of the heat source with respect to the cartridge 200 and/or different temperature zones.

In other examples, different coatings may be used achieve the temperature differential. For instance, the first temperature zone can include a first coating and the second temperature zone can include a second coating, different from the first coating, either of which may be different than the coating used for the third temperature zone.

In examples, the temperature zones correspond to different rotational rates and/or cycles of the rotating the cartridge 200 back and forth around the tip axis 202, which allows the cartridge 200 to iteratively rotate to allow temperature cycling (e.g., 30-40 times). Other examples are possible

A computing device, such as computing device 100, can include instructions to rotate the cartridge 200 at a series of rotational instructions, as desired for the type of tests and/or sample and various stages of preparing and testing the sample, including to allow for thermocycling.

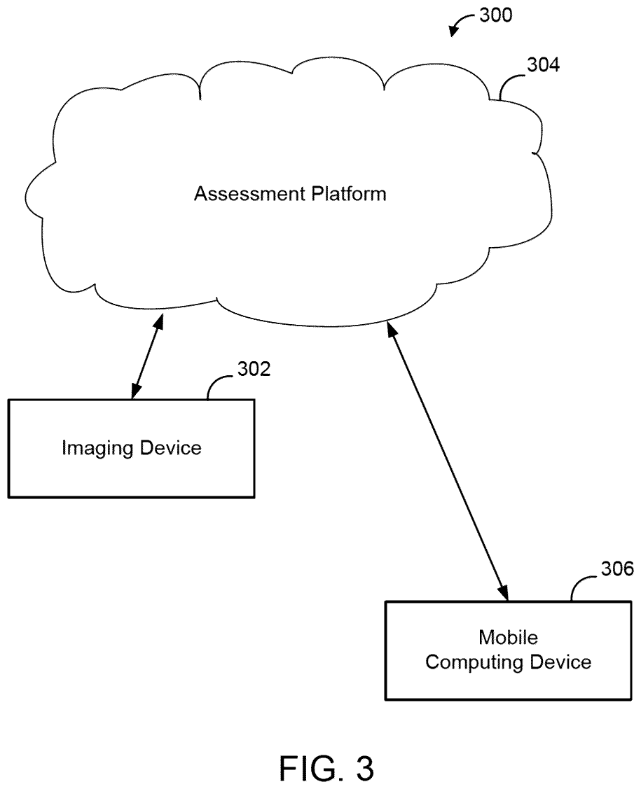

Now referring to FIG. 3, a computing system 300 configured for use with an imaging device 302 and a mobile computing device 306, according to an example embodiment. Example cartridges (e.g., cartridge 200) are compatible with an imaging device 302 that can read an optical signal present on a cartridge. Signals may include a color or intensity of light associated with the cartridge or may detect an image present on the cartridge that is associated with a particle (e.g., barcoded, shape, size, etc.) present in the cartridge. An imaging device 302 includes a computing device, such as computing device 100. It should also be readily understood that computing device 100 and the imaging device 302, and all of the components thereof, can be physical systems made up of physical devices, cloud-based systems made up of cloud-based devices that store program logic and/or data of cloud-based applications and/or services (e.g., perform at least one function of a software application or an application platform for computing systems and devices detailed herein), or some combination of the two.

In any event, a computing system 300 can include various components, such as the computing device 100, imaging device 302, a cloud-based assessment platform.

The imaging device 302 and/or components thereof can perform various acts and/or functions (many of which are described above). Examples of these and related features will now be described in further detail.

The imaging device 302 may collect data from a number of sources. In one example, the imaging device 302 may collect data from a database of images related to testing of samples, including one or more images of the sample and/or cartridge. The images may be uploaded to an assessment platform 304 and characteristics of the images may be output to a mobile computing device 306.

In an example, assessment platform 304 may collect data from one or more sensors communicably coupled to the imaging device 302, such as an imaging sensor, concerning a particular sample. In such examples, the assessment platform 304 may identify a characteristic of the sample or a testing result and transmit instructions to the mobile computing device 306 to cause a graphical user interface to display a graphical indication of the identified characteristic and/or testing result. In some examples, the assessment platform 304 may determine a testing result by utilizing one or more of: (i) an artificial neural network, (ii) a support vector machine, (iii) a regression tree, or (iv) an ensemble of regression trees.

In another example, the imaging device 302 may collect data from one or more sensors communicably coupled to the imaging device, such as an imaging sensor, concerning a particular sample and/or cartridge. In some examples, the assessment platform 304 may determine a characteristic of the sample and/or testing result by utilizing one or more of: (i) an artificial neural network, (ii) a support vector machine, (iii) a regression tree, or (iv) an ensemble of regression trees.

In some examples, images that are captured by the imaging device can be stored within a memory, such as a memory of computing device 100, to be subsequently analyzed.

In one example, the imaging device 302 may train a machine learning model using data associated images of sample and/or cartridge that share a characteristic with captured images of samples and/or cartridges. The machine learning model may be trained using training data that shares a characteristic and/or testing result with samples and/or cartridges to be analyzed by the imaging device. Training the machine learning model may include inputting one or more training images into the machine learning model, predicting, by the machine learning model, an outcome of a determined condition of the one or more training images, comparing the at least one outcome to the characteristic of the one or more training images, and adjusting, based on the comparison, the machine learning model.

In some examples, the training data may include labeled input images (supervised learning), partially labeled input images (semi-supervised learning), or unlabeled input images (unsupervised learning). In some examples, training may include reinforcement learning.

The machine learning model may include an artificial neural network, a support vector machine, a regression tree, an ensemble of regression trees, or some other machine learning model architecture or combination of architectures.

In some examples, the machine learning model of the imaging device 302 may be adjusted based on training such that if the outcome of a determined testing result matches the characteristic and/or testing result of the training images, the machine learning model is reinforced and if the outcome of a determined testing result does not match the characteristic of the training images, the machine learning model is modified. In some examples, modifying the machine learning model includes increasing or decreasing a weight of a factor within the neural network of the machine learning model. In other examples, modifying the machine learning model includes adding or subtracting rules during the training of the machine learning model.

Once the imaging device 302 has determined a characteristic of a sample in one or more images, the imaging device may transmit instructions that cause a computing device (e.g., the computing device 100) to display one or more graphical indications of the identified characteristic and/or the enhanced image.

In some example embodiments, the sample can be used for a variety of tests. For instance, these tests may include imaging of one or more of the following: (i) blood; (ii) urine; (iii) saliva; (iv) fecal matter; (v) secretion; (vi) excretion; (vii) FNA; (viii) lavage fluids; (ix) body cavity fluids; (x) semen; (xi) ear wax; (xii) skin cells; (xiii) biopsied samples, (xiv) exotics; (xv) cultured cells; (xvi) bacteria; (xvii) worms; (xviii) parasites; and (xix) ear mites, among other possibilities. Test may additionally include one or more of the following: blood coagulation test, polymerase chain reaction (PCR) test, and/or immunoassay, among other possibilities. For example, in some example embodiments, these tests may include one or more of the following blood chemistry tests: SDMA, Total T4 (TT4), Bile Acids, C-reactive Protein (CRP), Progesterone, Fructosamine, and/or Phenobarbital (PHBR), among other possibilities. For example, in some example embodiments, these tests may include one or more of the following blood chemistry profile tests that measure one or more of the following: ALB, ALB/GLOB, ALKP, ALT, AMYL, AST, BUN, BUN/CREA, Ca, CHOL, CK, Cl, CREA, CRP, FRU, GGT, GLOB, GLU, K, LAC, LDH, LIPA, Mg, Na, NH₃, PHOS, TBIL, TP, TRIG and/or URIC, among other possibilities. Other examples are possible.

### EXAMPLE METHODS AND ASPECTS

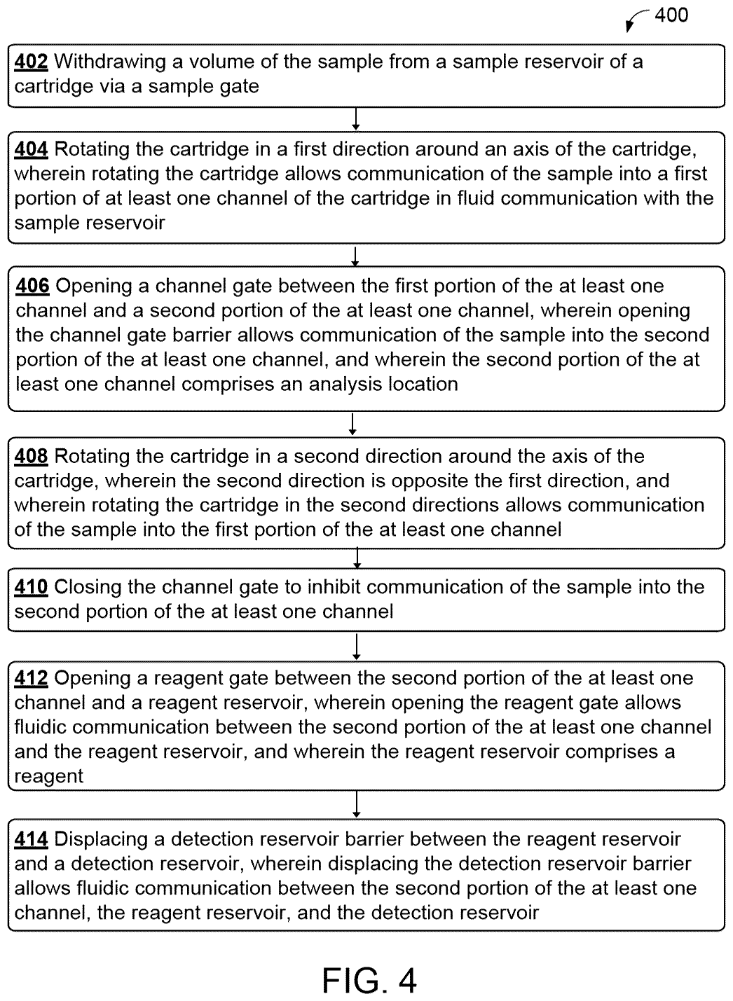

Now referring to FIG. 4, an example method of preparing a biological testing sample is disclosed. Method 400 shown in FIG. 4 presents an example of a method for preparing a biological testing sample that could be used with the components shown in FIGS. 2A-2B, for example. Further, devices or systems may be used or configured to perform logical functions presented in FIG. 4. In other examples, components of the devices and/or systems may be arranged to be adapted to, capable of, or suited for performing the functions, such as when operated in a specific manner. Method 400 may include one or more operations, functions, or actions as illustrated by one or more of blocks 402-414. Although the blocks are illustrated in a sequential order, these blocks may also be performed in parallel, and/or in a different order than those described herein. Also, the various blocks may be combined into fewer blocks, divided into additional blocks, and/or removed based upon the desired implementation.

At block 402, method 400 involves withdrawing a volume of the sample from a sample reservoir of a cartridge via a sample gate. In some examples, the sample reservoir comprises a buffer. In some examples, the sample gate also manipulates the sample by selectively impeding fluidic communication of the sample into the at least one channel.

At block 404, method 400 involves rotating the cartridge in a first direction around an axis of the cartridge, wherein rotating the cartridge allows communication of the sample into a first portion of at least one channel of the cartridge in fluid communication with the sample reservoir. In some examples, the sample gate manipulates the sample by selectively impeding fluidic communication of the sample into the at least one channel when the cartridge is rotated in the first direction around the axis. In some examples, the axis comprises a tip axis of the cartridge, and the tip axis is transverse to at least one channel and a tilt axis of the cartridge.

At block 406, method 400 involves opening a channel gate between the first portion of the at least one channel and a second portion of the at least one channel, wherein opening the channel gate allows communication of the sample into the second portion of the at least one channel, and wherein the second portion of the at least one channel comprises an analysis location. In some examples, the at least one channel extends in a substantially linear direction between the sample reservoir and a detection reservoir of the cartridge. In some examples, the analysis location comprises an optically transparent material In some examples, the at least one channel further comprises a first temperature zone and a second temperature zone, and wherein rotating the cartridge in a first direction around the tip axis communicates the sample to the first temperature zone, and rotating the cartridge in a second direction around the tip axis communicates the sample to the second temperature zone. In some examples, the at least one channel comprises a plurality of channels, wherein each channel of the plurality of channels comprises a respective reagent reservoir, a respective detection reservoir, and a respective analysis location. In some examples, the at least one channel comprises an incline surface when the cartridge is rotated around the tip axis. In some examples, the at least one channel comprises an incline surface when the cartridge is rotated around the tilt axis. In some examples, the at least one channel further comprises a plurality of particles on the surface of the at least one channel, wherein the plurality of particles are located proximate to the analysis location of the at least one channel.

At block 408, method 400 involves rotating the cartridge in a second direction around the axis of the cartridge, wherein the second direction is opposite the first direction, and wherein rotating the cartridge in the second directions promotes communication of the sample into the first portion of the at least one channel.

At block 410, method 400 involves closing the channel gate to inhibit communication of the sample into the second portion of the at least one channel.

At block 412, method 400 involves opening a reagent gate between the second portion of the at least one channel and a reagent reservoir, wherein opening the reagent gate allows fluidic communication between the second portion of the at least one channel and the reagent reservoir, and wherein the reagent reservoir comprises a reagent. In some examples, the reagent comprises one or more of: (i) a binding reagent; (ii) a wash reagent; (iii) a conjugate reagent; (iv) a fluorescent stain; (v) markers; (vi) transport; or (vii) beads. In some examples, the reagent is transported into the at least one channel when the cartridge is rotated in a second direction around the tip axis, and the reagent gate manipulates the reagent by selectively impeding fluidic communication of the reagent in the at least one channel when the cartridge is rotated in the second direction around the tip axis. In some examples, the first direction is opposite the second direction.

At block 414, method 400 involves displacing a detection reservoir barrier between the reagent reservoir and a detection reservoir, wherein displacing the detection reservoir barrier allows fluidic communication between the second portion of the at least one channel, the reagent reservoir, and the detection reservoir. In some examples, the detection reservoir comprises a detection fluid. In some examples, the detection reservoir barrier comprises a compressible material that, when compressed, causes movement of the detection reservoir barrier. In some examples, movement of the barrier allows fluidic communication between the reagent reservoir and the detection reservoir.

In some examples, the cartridge of method 400 further comprises a metering gate, wherein the metering gate meters a particular volume of the sample on the surface of the cartridge via the plurality of electrodes prior to fluidic communication of the particular volume of the sample into the at least one channel.

Various aspects and embodiments have been disclosed herein, but other aspects and embodiments will certainly be apparent to those skilled in the art. Additionally, the various aspects and embodiments disclosed herein are provided for explanatory purposes and are not intended to be limiting, with the true scope being indicated by the following claims.

What is claimed is:

1. A cartridge for testing a sample, wherein the cartridge comprises:
a plurality of electrodes;
a sample reservoir comprising an inlet and a sample gate, wherein the sample gate manipulates the sample on a surface of the cartridge via the plurality of electrodes, and wherein the sample reservoir is located at a first end of the cartridge; and
at least one channel, wherein each channel of the at least one channel is in selective fluidic communication with the sample reservoir, and wherein each channel of the at least one channel comprises:
(i) a channel gate, wherein the channel gate manipulates the sample at a first location of the at least one channel on the surface of the cartridge via the plurality of electrodes;
(ii) a reagent reservoir;
(iii) a reagent gate, wherein the reagent gate manipulates a reagent at a second location of the at least one channel on the surface of the cartridge via the plurality of electrodes;
(iv) a detection reservoir, wherein the detection reservoir comprises a barrier configured to separate the detection reservoir from the reagent reservoir, and wherein the wherein the detection reservoir is located at a second end of the cartridge distal from the first end; and
(v) an analysis location, wherein the analysis location is positioned proximate to a tip axis of the cartridge, and wherein the tip axis is transverse to the at least one channel and a tilt axis of the cartridge.

2. The cartridge of claim 1, wherein the sample reservoir comprises a buffer.

3. The cartridge of claim 1, wherein the sample gate manipulates the sample by selectively impeding fluidic communication of the sample into the at least one channel.

4. The cartridge of claim 1, wherein the sample is transported to the at least one channel when the cartridge is rotated in a first direction around the tip axis, and wherein the sample gate manipulates the sample by selectively impeding fluidic communication of the sample into the at least one channel when the cartridge is rotated in the first direction around the tip axis.

5. The cartridge of claim 4, wherein the reagent is transported to the at least one channel when the cartridge is rotated in a second direction around the tip axis, and wherein the reagent gate manipulates the reagent by selectively impeding fluidic communication of the reagent in the at least one channel when the cartridge is rotated in the second direction around the tip axis.

6. The cartridge of claim 5, wherein the first direction is opposite the second direction.

7. The cartridge of claim 1, wherein the at least one channel extends in a substantially linear direction between the sample reservoir and the detection reservoir.

8. The cartridge of claim 7, wherein the at least one channel further comprises a first temperature zone and a second temperature zone, and wherein rotating the cartridge in a first direction around the tip axis communicates the sample to the first temperature zone, and rotating the cartridge in a second direction around the tip axis communicates the sample to the second temperature zone.

9. The cartridge of claim 1, wherein the at least one channel comprises a plurality of channels, and wherein each channel of the plurality of channels comprises a respective reagent reservoir, a respective detection reservoir, and a respective analysis location.

10. The cartridge of claim 1, wherein the at least one channel comprises an incline surface when the cartridge is rotated around the tip axis.

11. The cartridge of claim 1, wherein the at least one channel comprises an incline surface when the cartridge is rotated around the tilt axis.

12. The cartridge of claim 1, wherein the at least one channel further comprises a plurality of particles on the surface of the at least one channel, and wherein the plurality of particles are located proximate to the analysis location of the at least one channel.

13. The cartridge of claim 1, wherein the reagent comprises one or more of: (i) a binding reagent; (ii) a wash reagent; (iii) a conjugate reagent; (iv) a fluorescent stain; (v) markers; (vi) transport; or (vii) beads.

14. The cartridge of claim 1, wherein the detection reservoir comprises a detection fluid.

15. The cartridge of claim 1, wherein the analysis location comprises an optically transparent material.

16. The cartridge of claim 1, wherein the barrier comprises a compressible material that, when compressed, causes movement of the barrier.

17. The cartridge of claim 16, wherein movement of the barrier allows fluidic communication between the reagent reservoir and the detection reservoir.

18. The cartridge of claim 1, wherein the sample reservoir further comprises a metering gate, wherein the metering gate meters a particular volume of the sample on the surface of the cartridge via the plurality of electrodes prior to fluidic communication of the particular volume of the sample into the at least one channel.

19. A method for testing a sample, the method comprising:
withdrawing a volume of the sample from a sample reservoir of a cartridge via a sample gate;
rotating the cartridge in a first direction around an axis of the cartridge, wherein rotating the cartridge allows communication of the sample into a first portion of at least one channel of the cartridge in fluid communication with the sample reservoir;
opening a channel gate between the first portion of the at least one channel and a second portion of the at least one channel, wherein opening the channel gate allows communication of the sample into the second portion of the at least one channel, and wherein the second portion of the at least one channel comprises an analysis location;
rotating the cartridge in a second direction around the axis of the cartridge, wherein the second direction is opposite the first direction, and wherein rotating the cartridge in the second directions allows communication of the sample into the first portion of the at least one channel;
closing the channel gate to inhibit communication of the sample into the second portion of the at least one channel;
opening a reagent gate between the second portion of the at least one channel and a reagent reservoir, wherein opening the reagent gate allows fluidic communication between the second portion of the at least one channel and the reagent reservoir, and wherein the reagent reservoir comprises a reagent; and
displacing a detection reservoir barrier between the reagent reservoir and a detection reservoir, wherein displacing the detection reservoir barrier allows fluidic communication between the second portion of the at least one channel, the reagent reservoir, and the detection reservoir.

20. A system for testing a sample, the system comprising:
a cartridge comprising:
a plurality of electrodes;
a sample reservoir comprising an inlet and a sample gate, wherein the sample gate manipulates the sample on a surface of the cartridge via the plurality of electrodes, and
wherein the sample reservoir is located at a first end of the cartridge; and
at least one channel, wherein each channel of the at least one channel is in selective fluidic communication with the sample reservoir, and wherein each channel of the at least one channel comprises:
(i) a channel gate, wherein the channel gate manipulates the sample at a first location of the at least one channel on the surface of the cartridge via the plurality of electrodes;
(ii) a reagent reservoir;
(iii) a reagent gate, wherein the reagent gate manipulates a reagent at a second location of the at least one channel on the surface of the cartridge via the plurality of electrodes;
(iv) a detection reservoir, wherein the detection reservoir comprises a barrier configured to separate the detection reservoir from the reagent reservoir, and wherein the wherein the detection reservoir is located at a second end of the cartridge distal from the first end; and
(v) an analysis location, wherein the analysis location is positioned proximate to a tip axis of the cartridge, and wherein the tip axis is transverse to the at least one channel and a tilt axis of the cartridge; and
an imaging device comprising:
an imaging sensor configured to capture one or more images of the sample at the analysis location; and
a computing device configured to analyze the captured one or more images.
